(19) United States
(12) Patent Application Publication
(10) Pub. No.: US 2014/0063785 A1
(43) Pub. Date: Mar. 6, 2014

(54) DIRECT BACKLIGHT MODULE AND LED ENCAPSULATION THEREOF

(71) Applicant: Gang Yu, Shenzhen (CN)

(72) Inventor: Gang Yu, Shenzhen (CN)

(73) Assignee: SHENZHEN CHINA STAR OPTOELECTRONICS TECHNOLOGY CO. LTD., Shenzhen (CN)

(21) Appl. No.: 13/642,549

(22) PCT Filed: Sep. 6, 2012
(86) PCT No.: PCT/CN12/81052

§ 371 Date: Oct. 21, 2012

(30) Foreign Application Priority Data
Aug. 31, 2012 (CN) CN 201210318012.X

(51) Int. Cl. G09F 13/04

(52) U.S. Cl. CPC G09F 13/04
USPC 362/97.1

(57) ABSTRACT

The present invention discloses an LED encapsulation for direct backlight module, which includes a base, which is mounted to an LED chip set on a backplane of the direct backlight module; and a support section, which extends from a surface of the base for supporting and fixing a diffusion board of the backlight module. The present invention also discloses a direct backlight module. Practicing the direct backlight module and the LED encapsulation thereof according to the present invention eliminates the need for individually mounting a support structure on the backplane of the backlight module to support a diffusion board and reduces the working hours and the expense for processing the backplane so as to further reduce the cost of the backlight module.

### CROSS REFERENCE TO RELATED APPLICATIONS

This application claims the priority of Chinese Patent Application No. 201210318012.X filed on Aug. 31, 2012, the disclosure of which is incorporated herein by reference in its entirety.

### BACKGROUND OF THE INVENTION

1. Field of the Invention

The present invention relates to the field of manufacturing of liquid crystal panel, and in particular to a direct backlight module and an LED (Light-Emitting Diode) encapsulation thereof.

2. The Related Arts

As shown in FIG. 3, a schematic view of a portion of a conventional direct backlight module is given. The direct backlight module comprises: a backplane 91, an LED chip 92 mounted to the backplane 91, and diffusion board 93 adjacent to the backplane 91. The LED chip 92 needs an encapsulation 94 to control light emission from the LED. The diffusion board 93 needs to be supported and fixed by a support member 95.

In other words, in an assembling process of direct backlight modules having the above structure, two operations are needed to assemble the encapsulation 94 and the support member 95. This extends the working hours for assembling and also needs to make a positioning hole in the backplane 91 to mount the support member 95. The manufacturing expense of the backplane 91 is thus increased and this is disadvantageous for cost reduction.

### SUMMARY OF THE INVENTION

The technical issue to be addressed by the present invention is to provide a direct backlight module and an LED encapsulation thereof, wherein no individual support structure is necessarily mounted to a backplane of the backlight module for supporting a diffusion board thereby reducing the processing time and processing expense of the backplane and thus further reducing the cost of the backlight module.

To address the above technical issue, an embodiment of the present invention provides an LED encapsulation for direct backlight module, which comprises:

a base, which is mounted to an LED chip set on a backplane of the direct backlight module; and

a support section, which extends from a surface of the base for supporting and fixing a diffusion board of the backlight module.

Preferably, the support bar is integrally formed on the base.

Preferably, the support section comprises a support bar having an end connected to the base and the support bar has a diameter that is gradually reduced.

Preferably, the base comprises a cap having a hollow interior and the cap is of a hemispheric configuration.

The present invention also discloses a direct backlight module, which comprises a backplane and a diffusion board. The backplane comprises a plurality of LED chips mounted thereon. The direct backlight module further comprises a plurality of LED encapsulations that have an end respectively mounted on the LED chips, the LED encapsulations having an opposite end that supports and fixes the diffusion board.

Preferably, each of the LED encapsulations comprises a base mounted on the LED chip and a support section extending from a surface of the base in such a way that the support section has an end positioned against the diffusion board.

Preferably, the support section comprises a support bar having an end connected to the base and the support bar has a diameter that is gradually reduced.

Preferably, the support bar is integrally formed on the base.

The direct backlight module and the LED encapsulation thereof provided by the present invention have the following efficacies. Since the LED encapsulation comprises a support section formed on the base, the base may encapsulate an LED chip mounted on a backplane of the backlight module in such a way that the support section fixes the diffusion board of the backlight module at a location adjacent to the backplane without individually installing the support section to support the diffusion board, so as to reduce the processing hours and the processing expense for processing the backplane and further lowering down the cost of the backlight module.

### BRIEF DESCRIPTION OF THE DRAWINGS

FIG. 1 is a perspective view showing an LED encapsulation for direct backlight module according to an embodiment of the present invention;

FIG. 2 is a schematic view showing a portion of the direct backlight module according to the embodiment of the present invention; and

FIG. 3 is a schematic view showing a portion of a conventional direct backlight module.

### DETAILED DESCRIPTION OF THE PREFERRED EMBODIMENTS

A description will be given to preferred embodiments of the present invention, reference being had to the attached drawings.

An embodiment of the present invention provides an LED encapsulation for direct backlight module, which comprises:

a base 1, which is mounted to an LED chip set on a backplane of the backlight module; and

a support section 2, which extends from a surface of the base 1 for supporting and fixing a diffusion board of the backlight module.

The LED encapsulation having the above described structure for encapsulating an LED chip on the backplane may realize simultaneous installation of the support section 2 at the same time when the light source is mounted, thereby achieving simultaneously a support to the diffusion board. The LED encapsulation having such a structure eliminates the need for making a positioning hole in the backplane for mounting and fixing a support section 2 thereby reducing the working hours and expense for processing the backplane and thus further reducing the cost of manufacturing backlight module. The structure of the LED encapsulation for direct backlight module according to the present invention will be described in more details.

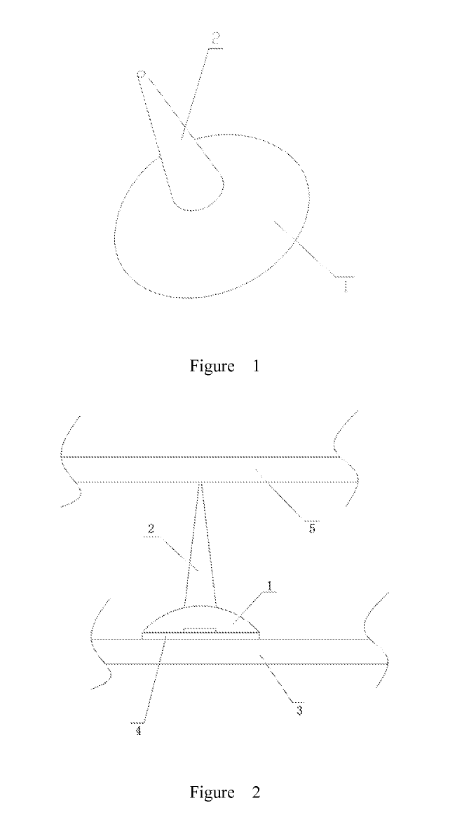

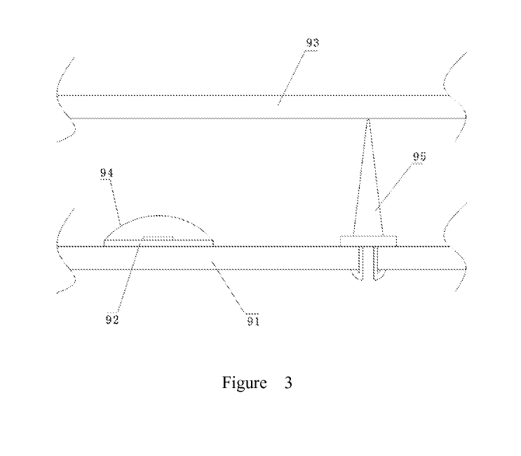

Referring to FIG. 1, in the instant embodiment, the base 1 is arranged as a hollow cap having a hemispheric configuration. In mounting the LED chip, the base 1 can be used to cover the site on the backplane in which the LED chip is present. With the base 1 covering the LED chip, the purpose of controlling light emission of the LED can be achieved.

The support section 2 is a support structure integrally formed on the base 1 and extends outward from a surface of the base 1. The function of the support section 2 is to provide support to a diffusion board of the backlight module arranged adjacent to the backplane. Since the support section 2 is directly connected to the base 1, the process of mounting the light source is also a process of fixing the support section 2. In other words, the member for mounting LED having the above described structure can realize encapsulation of LED and support of diffusion board at the same time.

A preferred embodiment of the support section 2 will be described.

The support section 2 is a support bar having an end connected to an outside surface of the base 1 and has a diameter that is gradually reduced so that an end of the support bar that has a small diameter is a support point for supporting the diffusion board. A plurality of LED encapsulations of the same structure is respectively mounted around circumferences of LED chips, whereby due to the bases 1 and the support bars are respectively of identical sizes, the ends of the plurality of support bars of identical height are located on the same plane to simultaneously support the diffusion board.

In other embodiments of the support section 2, other commonly known shapes may be used, such as cylinder, rectangular prism, circular stage, and rectangular stage. Similarly, the base 1 is not limited to the embodiment of hemispheric configuration described above and can be modified according to the shape, number, and arrangement of the LED chips.

As shown in FIG. 2, the present invention also discloses direct backlight module, which comprises a backplane 3, a plurality of LED chips 4 mounted on the backplane 3, and a diffusion board 5. The direct backlight module further comprises a plurality of LED encapsulations. An end of the plurality of LED encapsulations is set to respectively cover the plurality of LED chips 4 and an opposite end of the plurality of LED encapsulations supports and fixes the diffusion board 5 to be located adjacent to the backplane 3.

In a preferred embodiment, each LED encapsulation comprises a base 1 mounted on an LED chip 4 and a support section 2 extending from a surface of the base 1. The support section 2 has an end positioned against a diffusion board 5.

The direct backlight module of the present invention realizes simultaneous achievements of encapsulation of LED and support of a corresponding diffusion board. And, at the same time of mounting a light source, the purpose of supporting a support section 2 is also achieved. A direct backlight module with such a structure eliminates the need to make a positioning hole in the backplane 3 to fix the support section 2, thereby reducing the working hours and expense for processing the backplane and thus further reducing the cost for manufacturing backlight module.

Practicing the direct backlight module according to the present invention is identical to the embodiment of the LED encapsulation for direct backlight module. No repeated description will be given.

Practicing the direct backlight module and the LED encapsulation thereof according to the present invention provides the following benefits. Since the LED encapsulation comprises a support section formed on the base, the base may encapsulate an LED chip mounted on a backplane of the backlight module in such a way that the support section fixes the diffusion board of the backlight module at a location adjacent to the backplane without individually installing the support section to support the diffusion board, so as to reduce the processing hours and the processing expense for processing the backplane and further lowering down the cost of the backlight module.

What is claimed is:

1. An LED encapsulation for direct backlight module, comprising:
a base, which is mounted to an LED chip set on a backplane of the direct backlight module; and
a support section, which extends from a surface of the base for supporting and fixing a diffusion board of the backlight module.

2. The LED encapsulation for direct backlight module as claimed in claim 1, wherein the support section comprises a support bar having an end connected to the base.

3. The LED encapsulation for direct backlight module as claimed in claim 2, wherein the support bar has a diameter that is gradually reduced.

4. The LED encapsulation for direct backlight module as claimed in claim 2, wherein the support bar is integrally formed on the base.

5. The LED encapsulation for direct backlight module as claimed in claim 1, wherein the support bar is integrally formed on the base.

6. The LED encapsulation for direct backlight module as claimed in claim 1, wherein the base comprises a cap having a hollow interior, the cap being of a hemispheric configuration.

7. A direct backlight module, comprising a backplane and a diffusion board, the backplane comprising a plurality of LED chips mounted thereon, wherein the direct backlight module further comprises a plurality of LED encapsulations that have an end respectively mounted on the LED chips, the LED encapsulations having an opposite end that supports and fixes the diffusion board.

8. The direct backlight module as claimed in claim 7, wherein each of the LED encapsulations comprises a base mounted on the LED chip and a support section extending from a surface of the base, the support section having an end positioned against the diffusion board.

9. The direct backlight module as claimed in claim 8, wherein the support section comprises a support bar having an end connected to the base and the support bar has a diameter that is gradually reduced.

10. The direct backlight module as claimed in claim 9, wherein the support bar is integrally formed on the base.

11. The direct backlight module as claimed in claim 8, wherein the support bar is integrally formed on the base.

12. The direct backlight module as claimed in claim 8, wherein the base comprises a cap having a hollow interior, the cap being of a hemispheric configuration.

13. A direct backlight module, comprising a backplane and a diffusion board, the backplane comprising an LED chip mounted thereon, wherein the direct backlight module further comprises an LED encapsulation, the LED encapsulation comprises:
a base mounted on the LED chip and a support section extending from a surface of the base, the support section having an end positioned against the diffusion board.

14. The direct backlight module as claimed in claim 13, wherein the support section comprises a support bar having an end connected to the base.

15. The direct backlight module as claimed in claim 14, wherein the support bar has a diameter that is gradually reduced.

16. The direct backlight module as claimed in claim 15, wherein the support bar is integrally formed on the base.

17. The direct backlight module as claimed in claim 13, wherein the support bar is integrally formed on the base.

18. The direct backlight module as claimed in claim 13, wherein the base comprises a cap having a hollow interior, the cap being of a hemispheric configuration.
